(19) United States
(12) Patent Application Publication
(10) Pub. No.: US 2017/0231235 A1
(43) Pub. Date: Aug. 17, 2017

(54) REDUCED SODIUM BAKERY PRODUCT COMPRISING FILLING OR TOPPING

(71) Applicant: NESTEC S.A., Vevey (CH)

(72) Inventors: Laurent Forny, Lausanne (CH); Jian Li, Chagrin Falls, OH (US); Cedric Dubois, Lavigny (CH); Marina Dupas-Langlet, Orbe (CH); Lionel Jublot, Forel (CH)

(73) Assignee: NESTEC S.A., Vevey (CH)

(21) Appl. No.: 15/519,253

(22) PCT Filed: Oct. 12, 2015
(86) PCT No.: PCT/EP2015/073574

§ 371 Date: Apr. 14, 2017

Related U.S. Application Data
(60) Provisional application No. 62/065,063, filed on Oct. 17, 2014.

(51) Int. Cl. A21D 13/41; A23L 33/20; A23L 27/40; A21D 2/02; A21D 13/22

(52) U.S. Cl. CPC A21D 13/41; A21D 2/02; A21D 13/22; A23L 27/40; A23L 33/20; A23V 2002/00

(57) ABSTRACT

The present invention relates to a bakery product. In particular the invention relates to a bakery product comprising dough and a filling or topping wherein the bakery product has an exposed dough surface having a coating comprising sodium chloride. A further aspect of the invention is a process for manufacturing a bakery product.

### FIELD OF THE INVENTION

The present invention relates to a bakery product. In particular the invention relates to a bakery product comprising dough and a filling or topping wherein the bakery product has an exposed dough surface having a coating comprising sodium chloride. A further aspect of the invention is a process for manufacturing a bakery product.

### BACKGROUND OF THE INVENTION

Sodium intake by consumers has been steadily increasing up to a point much higher than recommended by health authorities. The high intake of sodium has often been related to high blood pressure, which leads to many cardiovascular diseases, and also has been related to renal disease, stomach cancer, bone demineralization, and other conditions.

Considerable efforts have been made to reduce sodium in processed foods. Existing approaches for reducing sodium include controlling the total level of salt, using salt substitutes, and/or using flavour enhancers. However, reducing sodium has been a challenge because these existing approaches affect not only saltiness, but also flavour and texture. For example, reducing sodium in foods usually negatively impacts taste because sodium, in particular sodium chloride, provides basic flavour by itself and also enhances other flavours present in the food. Typical quality deteriorations related with the existing sodium reduction approaches are insufficient saltiness, off flavor and taste, alteration of appearance and inferior texture. Of course, flavour and texture are extremely important factors in the decision whether to consume nutritious foods or not and the consumer enjoyment of nutritious foods.

An object of the present invention is to improve the state of the art and to provide an improved solution to overcome at least some of the inconveniences described above. As used in this specification, the words “comprises”, “comprising”, and similar words, are not to be interpreted in an exclusive or exhaustive sense. In other words, they are intended to mean “including, but not limited to”. The object of the present invention is achieved by the subject matter of the independent claims. The dependent claims further develop the idea of the present invention.

Accordingly, the present invention provides in a first aspect a bakery product comprising dough and a filling or topping selected from the group consisting of cheese, meat, vegetables and combinations of these, wherein the bakery product has an exposed dough surface having a coating comprising a salty tastant.

In a second aspect, the invention relates to a process for manufacturing a bakery product comprising the steps of forming a dough; combining the dough with a filling or topping selected from the group consisting of cheese, meat, vegetables and combinations of these; and applying a coating comprising sodium chloride to an exposed dough surface wherein at least 30 wt. % of the total sodium chloride in the coating and dough is present in the coating.

It has been surprisingly found by the inventors that applying a coating comprising sodium chloride to an exposed surface of a bakery product comprising dough and a filling or topping increases the saltiness perception to the extent that such products to be formulated with a reduced overall amount of salt. For example, a savoury turnover could be reformulated with only 80% of the original sodium chloride content when part of the sodium chloride was coated onto the outer dough surface of the turnover. The savoury turnover with sodium chloride coated onto the outer dough surface was found to taste as salty as the original higher sodium chloride-content turnover, with no negative effect on dough texture.

### DETAILED DESCRIPTION OF THE INVENTION

Consequently the present invention relates in part to a bakery product comprising dough and a filling or topping selected from the group consisting of cheese, meat, vegetables and combinations of these, wherein the bakery product has an exposed dough surface having a coating comprising sodium chloride, and wherein at least 30 wt. % of the total sodium chloride in the coating and dough is present in the coating.

The term “exposed dough surface” in this specification refers to an external dough surface of the bakery product which can be readily recognised as such, for example it is not covered by another major component. An exposed dough surface would include surfaces with a minor coating such as an egg wash. The term dough refers to uncooked dough, partially cooked dough or cooked dough. Uncooked dough is a thick malleable mixture of a starch-containing material and a liquid. The starch-containing material may be selected from the group consisting of wheat flour, maize starch, cornmeal, buckwheat flour, millet flour, amaranth flour, quinoa flour, potato starch, sweet potato flour, tapioca starch, rice starch, rice flour, sorghum flour, bean flour, pea flour, pea starch, soy flour, chickpea flour, cowpea flour, lentil flour, bambara bean flour, lupin flour, chestnut flour and combinations of these. The dough may be gluten free. Cooked dough may be for example bread or pastry.

By being applied to an exposed dough surface of the bakery-product, the coating comprising sodium chloride immediately comes into contact with saliva and or the tongue of the consumer when the bakery product is eaten. This provides a stronger salty response than having the same amount of salt within the product matrix, where other components may interfere with the saltiness perception, and much of the salty tastant may be swallowed without reaching salt taste receptors in the mouth. Humans have added common salt (sodium chloride) to their food for thousands of years and have grown accustomed to its taste. As a result, the most desirable saltiness profile is that obtained with sodium chloride. It is therefore an advantage that the bakery product of the invention can provide a sodium chloride saltiness profile, while allowing an overall reduction in sodium chloride in the product to be made. The proportion of the total sodium chloride in the coating and dough which is present in the coating needs to be above a threshold level before a noticeable effect on saltiness perception is achieved, for example an effect which would enable an overall reduction in sodium chloride content. In the bakery product of the invention at least 30 wt. % of the total sodium chloride in the coating and dough should present in the coating, for example at least 40 wt. % of the total sodium chloride in the coating and dough may be present in the coating, for further example at least 50 wt. % of the total sodium chloride in the coating and dough may present in the coating. At least 20 wt. % of the total sodium chloride in the bakery product of the invention may be present in the coating, for example at least 30 wt. %, for further example at least 40 wt. %.

Sodium chloride may only be present in the coating, but in this case, a non-sodium chloride salty tastant should be added to the bakery product otherwise the sodium chloride in the coating would give a strong initial salty taste, fading to a rather bland taste as the rest of the bakery product was broken down in the mouth. Salt is used in most bread dough recipes to control the rate of fermentation and to give flavour. The presence of salt in a yeast-leavened dough inhibits fermentation which, in a traditional wheat flour dough strengthens the developing gluten. This results in a bread with a stable crumb, a long shelf-life and more taste than breads without salt. It is therefore beneficial to incorporate some sodium chloride in fermented dough. The dough in the bakery product of the invention may be a fermented dough and between 10 and 70 wt. % of the total sodium chloride in the coating and dough may be present in the dough, for example between 20 and 60 wt. % of the total sodium chloride in the coating and dough may be present in the dough, for further example between 30 and 50 wt. % of the total sodium chloride in the coating and dough may be present in the dough.

The greater the proportion of the external surface area which has a coating comprising sodium chloride, the more likely the sodium chloride is to come into direct contact with taste receptors in the mouth. At least 30% of the total external dough surface area of the bakery product of the invention may have a coating comprising sodium chloride, for example at least 50% of the total external dough surface area of the bakery product of the invention may have a coating comprising sodium chloride.

The bakery product according to the invention allows the total sodium chloride in the product formulation to be decreased. For example the bakery product of the invention may contain less than 750 mg sodium chloride per 100 g, for further example the bakery product of the invention may contain less than 400 mg sodium chloride per 100 g. Once added to the bakery product, the sodium chloride may not be present as sodium chloride as such, for example it may be dissolved in water, with sodium and chloride ions being independent, however it should be understood in the current application that the amount of sodium chloride in the bakery product refers to the amount originally added in that form.

Sodium chloride may not be the only source of sodium in a bakery product, for example sodium bicarbonate (baking soda) may be added as a leavening agent. The bakery product of the invention may have a sodium level of below 600 mg per 100 g, for example it may have a sodium level below 300 mg per 100 g, for further example below 140 mg of sodium per 100 g. The U.S. Food and Drug Administration define meals and main dishes to be “low in sodium” if they contain 140 mg or less of sodium per 100g. The bakery product of the invention may be a ready-to-bake product, for example it may be uncooked or partially cooked. The ready-to-bake bakery product may be sold frozen or chilled.

The bakery product of the invention may comprise a topping, for example the bakery product may be a pizza, quiche, or tarte flambee. The bakery product of the invention is particularly advantageous when in the form of a bakery product comprising a topping, as slices of these bakery products are almost always placed in the mouth oriented with the topping uppermost. This orientation allows a coating applied to the base of the bakery product (e.g. the pizza base) to rapidly come in contact with the tongue of the consumer, providing a strong initial salty sensation from the sodium chloride comprised in the coating. The bakery product of the invention may be a pizza and the coating may be on the base of the pizza. The bakery product of the invention may comprise a filling, which may be enclosed, or mostly enclosed. Examples of such filled bakery products include savoury turnovers, Cornish pasties, empanadas, samosas, bridies and sausage rolls. For bakery products comprising a filling the coating may be applied all around the external surface of the product to ensure good contact with the tongue regardless of the orientation in the mouth chosen by the consumer, or it may be applied in discrete areas. Many filled bakery products have a flat base on which the product sits during baking, for example a Cornish pasty. During consumption the flat surface is naturally placed in the mouth in contact with the tongue as this orientation fits the mouth shape best. The coating comprising sodium chloride is therefore particularly effective when applied to the flatter base surface.

Turnovers may be made by placing a filling on a piece of dough, folding the dough over, and sealing it before baking. Alternatively, a top and bottom dough sheet may be used to cover a filling. Fillings may also be enclosed, or partly enclosed, by co-extrusion of dough and filling. One type of savoury turnover, sometimes called a filled sandwich, is the Nestlé product HOT POCKETS® which is designed to be heated in a microwave before consumption. The bakery product of the invention may be a savoury turnover. A pizza or savoury turnover according to the invention may have a sodium chloride content in the dough of below 500 mg per 100 g, for example below 400 mg per 100 g.

The coating of the bakery product of the invention may further comprise an edible gum. A gum will help the coating adhere to the exposed dough surface. The gum may be selected from the group consisting of carrageenan, alginate, gellan gum, pectin, maltodextrin, xanthan gum, cellulose derivatives and combinations of these.

The coating of the bakery product of the invention may further comprise an ingredient selected from the group consisting of herbs, spices, nuts, flour and combinations of these. Many bakery products are traditionally finished with these ingredients and their use may make the presence of sodium chloride in the coating visually less noticeable. For example, a product such as a pizza is often finished with a coating of flour on its base, which helps prevent the pizza sticking to preparation surfaces. A mixture of flour and sodium chloride powders adhered to the base of the pizza would provide a traditional appearance and yet enable a salt reduction to be achieved without a perceived change in saltiness. Similarly, a mixture of sodium chloride, flour and herbs applied to the top of a filled bakery product would provide a traditional appearance and yet enable a salt reduction to be achieved without a perceived change in saltiness. Ingredients such as herbs and spices may provide flavours which make a reduced salt product more acceptable to consumers.

In a further embodiment, the present invention pertains to a process for manufacturing a bakery product comprising the steps of forming a dough; combining the dough with a filling or topping selected from the group consisting of cheese, meat, vegetables and combinations of these; and applying a coating comprising sodium chloride to an exposed dough surface wherein at least 30 wt. % of the total sodium chloride in the coating and dough is present in the coating. The coating may be applied to the dough when the dough is uncooked, partially cooked or fully cooked. The coating may be applied before or after the filling or topping is applied. If the coating is applied before the filling or topping is applied then it should be applied, at least in part, to a surface which will remain exposed in the final product.

The coating applied in the process of the invention may be a powder composition comprising sodium chloride. For example, dough may be placed onto a surface spread with the powder composition, either before or after the dough is shaped. As further examples, the dough may be sprayed with a dry spray of powder, or the dough may pass into or over a fluidized bed of the powder composition. In the case of uncooked dough, the powder will usually adhere to the dough unaided, but in the case of cooked dough it may be necessary to apply a sticky substance such as an edible gum to the cooked dough before applying the powder composition.

The coating applied in the process of the invention may be a dispersion of sodium chloride in oil, or the coating may be an aqueous solution comprising sodium chloride. Such a solution may be sprayed onto the dough. The aqueous solution may further comprise an edible gum. The coating may be applied by any of the methods known in the art, for example the coating may be applied by a method selected from the group consisting of spraying, dipping, contacting (including pressing) and brushing. The bakery product manufactured by the process of the invention may be a pizza or a savoury turnover.

Those skilled in the art will understand that they can freely combine all features of the present invention disclosed herein. In particular, features described for the product of the present invention may be combined with the process of the present invention and vice versa. Further, features described for different embodiments of the present invention may be combined. Where known equivalents exist to specific features, such equivalents are incorporated as if specifically referred to in this specification. Further advantages and features of the present invention are apparent from the non-limiting examples.

### EXAMPLES

### Example 1

### Salt Reduction in Pizza

The effect on saltiness perception of spraying a brine solution onto the base of a pizza was examined.

The reference was a pilot plant scale recipe for a “rising crust” pizza. The pizza base was made from a 600 g of yeast-leavened dough which contained 6.26 g sodium chloride. For the comparison product, the sodium chloride in the dough was reduced to 38 wt. % of the reference level (2.37 g sodium chloride in 600 g uncooked dough) and a further 2.0 g of sodium chloride was sprayed onto the underside of the pizza base as a brine solution after the dough was shaped. This gave a total sodium chloride content in the coated base of 4.37 g which is 70 wt. % of sodium chloride content of the reference pizza base. Despite containing 30 wt. % less salt than the reference, the coated pizza base was found to taste much saltier than the reference when baked.

### Example 2

### Salt Reduction in a Savoury Turnover

The effect on saltiness perception of applying a coating of powdered salt onto the external dough surface of a savoury turnover was examined.

| | Sample | Salt |
|---|---|---|
| A | Reference | 100% |
| | | 100% in dough |
| B | Negative control | 80% |
| | | 80% in dough |
| C | Salt coated | 80% |
| | | 30% in coating |

The reference was a pilot plant scale recipe for a ham and cheese filled sandwich. The dough casing was made from 90.0 g of dough (50.4 g top layer, 39.6 g bottom layer) which contained 1120 mg sodium chloride. During the rolling out of the top dough layer, a light layer of dusting flour was applied. A filling was then placed on the bottom layer, before the top layer was applied (flour on exterior) and the sandwich was frozen.

For the negative control (B), the sodium chloride in the dough was reduced to 80 wt. % of the reference level (896 mg sodium chloride in 90.0 g uncooked dough) with no other changes. For sample C, the sodium chloride in the dough was reduced to 50 wt. % (560 mg sodium chloride in 90.0 g uncooked dough) with an additional 30 wt. % of sodium chloride (336 mg sodium chloride) added to the top dough layer together with the dusting flour. Together with the flour this adhered to the dough and formed a coating. 37.5 wt. % of the total sodium chloride content of the coating and dough was present in the coating.

After baking, the sandwiches were assessed by a trained sensory panel. Eleven assessors convened during glossary development session to discuss and agree upon a common language to fully describe the samples included in the test. Samples were evaluated using a 15-point scale where 0=none and 15=extreme. Panelists evaluated each product 2 times according to a randomized balanced block design for serving position. This provides a dataset sufficient for statistical analysis.

A summary of the sensory results compared to the reference are presented in the table below.

| | Sample | Salt | Saltiness | Texture |
|---|---|---|---|---|
| B | Negative | 80% | Overall saltiness and salt | Similar texture |
| | control | 80% in | persistence were the lowest. | to reference |
| | | dough | | |
| C | Salt coated | 80% | Similar saltiness to | Similar texture |
| | | 30% in | reference | to reference |
| | | coating | | |

It can be seen that the overall saltiness and salt persistence of the negative control sample (B) (20 wt. % salt reduction) was lower than the reference, showing that a simple reduction of salt from the reference recipe would have a negative impact on saltiness perception. However, applying a coating comprising sodium chloride to an exposed dough surface allowed an overall salt reduction of 20 wt. % without detrimentally affecting the saltiness perception or texture.

1. Bakery product comprising dough and a filling or topping selected from the group consisting of cheese, meat, vegetables and combinations of these, wherein the bakery product has an exposed dough surface having a coating comprising sodium chloride, and wherein at least 30 wt. % of the total sodium chloride in the coating and dough is present in the coating.

2. A bakery product according to claim 1 wherein the dough is a fermented dough and wherein between 10 and 70 wt. % of the total sodium chloride in the coating and dough is present in the dough.

3. A bakery product according to claim 1 wherein at least 30% of the total external dough surface area has a coating comprising sodium chloride.

4. A bakery product according to claim 1 wherein the bakery product contains less than 750 mg sodium chloride per 100 g.

5. A bakery product according to claim 1 having a sodium level of below 600 mg per 100 g.

6. A bakery product according to claim 1 wherein the bakery product is a pizza and the coating is on the base of the pizza.

7. A bakery product according to claim 1 wherein the coating further comprises an edible gum.

8. A bakery product according to claim 1 wherein the coating further comprises an ingredient selected from the group consisting of herbs, spices, nuts, flour and combinations of these.

9. Process for manufacturing a bakery product comprising the steps of: forming a dough; combining the dough with a filling or topping selected from the group consisting of cheese, meat, vegetables and combinations of these; and applying a coating comprising sodium chloride to an exposed dough surface wherein at least 30 wt. % of the total sodium chloride in the coating and dough is present in the coating.

10. A process according to claim 9 wherein the coating is a powder composition comprising sodium chloride.

11. A process according to claim 9 wherein the coating comprises a dispersion of sodium chloride in oil.

12. A process according to claim 9 wherein the coating is an aqueous solution comprising sodium chloride.

13. A process according to claim 12 wherein the aqueous solution further comprises an edible gum.

14. A process according to claim 9 wherein the coating is applied by a method selected from the group consisting of spraying, dipping, contacting and brushing.

15. A process according to claim 9 wherein the bakery product is a pizza or a savoury turnover.
